(19) United States
(12) Patent Application Publication
(10) Pub. No.: US 2023/0393699 A1
(43) Pub. Date: Dec. 7, 2023

(54) LIVE SESSIONS ON LOCK SCREEN

(71) Applicant: Apple Inc., Cupertino, CA (US)

(72) Inventors: Neil N. DESAI, San Francisco, CA (US); Antony J. DZERYN, Round Rock, TX (US); Patrick R. METCALFE, Santa Clara, CA (US); Can ARAN, Palo Alto, CA (US)

(21) Appl. No.: 18/140,541

(22) Filed: Apr. 27, 2023

Related U.S. Application Data
(60) Provisional application No. 63/349,029, filed on Jun. 3, 2022.

(51) Int. Cl. G06F 3/0481; G06F 3/14; G06F 9/451

(52) U.S. Cl. CPC G06F 3/0481; G06F 3/14; G06F 9/451

(57) ABSTRACT

Systems and methods for presenting live sessions on electronic device lock screens are disclosed. In one or more implementations, an application process provides, to a system process executing on a computing device, a user interface template, wherein the user interface template defines one or more pre-defined regions of a user interface view. The system process may subsequently receive additional data. The system process may render the user interface view on a lock screen of the computing device according to the user interface template, wherein the user interface view comprises the additional data included in the one or more pre-defined regions.

### CROSS REFERENCE TO RELATED APPLICATIONS

This application claims the benefit of priority to U.S. Provisional Patent Application No. 63/349,029, entitled “Live Sessions on Lock Screen,” filed on Jun. 3, 2022, the disclosure of which is hereby incorporated herein in its entirety.

### TECHNICAL FIELD

The present description relates generally to electronic devices, including, for example, presenting live sessions on electronic device lock screens.

### BACKGROUND

Electronic devices typically provide applications for presenting content on a user interface of the application. To access the content, a user is typically required to unlock the device, launch the application, and find the correct portion of the user interface of the application to access the desired content.

### BRIEF DESCRIPTION OF THE DRAWINGS

Certain features of the subject technology are set forth in the appended claims. However, for purpose of explanation, several implementations of the subject technology are set forth in the following figures.

FIG. 1 illustrates a perspective view of an example electronic device that may implement various aspects of the subject technology.

FIG. 2 illustrates a user interface (UI) view in a first state in accordance with one or more implementations.

FIG. 3 illustrates the UI view in a second state, in accordance with one or more implementations.

FIG. 4 illustrates the UI view in a third state, in accordance with one or more implementations.

FIG. 5 illustrates the UI view in a fourth state, in accordance with one or more implementations.

FIG. 6 illustrates a block diagram of an example electronic device generating an application UI view for display, in accordance with one or more implementations.

FIG. 7 illustrates a flow diagram of an example process for presenting a user interface view on a user interface of an electronic device according to aspects of the subject technology.

FIG. 8 illustrates a flow diagram of an example process for providing data associated with an application for presentation in a portion of a user interface view according to aspects of the subject technology.

FIG. 9 illustrates a flow diagram of an example process for rendering a new user interface view based on information received from an application executing in a sandbox mode according to aspects of the subject technology.

FIG. 10 illustrates an example computing device with which aspects of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Challenges may arise when generating application-related displays on a lock screen of a computing device because applications are typically restricted from accessing locked data and/or resources. However, it may be desirable to display data associated with an application on a lock screen of a computing device. Therefore, it may be desirable to generate a display associated with an application while restricting the application from running on the computing device and/or receiving information about the computing device and/or the lock screen.

In one or more implementations, a system process (or a user interface display process that is separate from the operating system) at an electronic device receives, from an application, one or more templates defining information associated with a user interface view of the application. The one or more templates include one or more pre-defined regions for displaying live data. The system process can cause a user interface view to be rendered including the template and the live data.

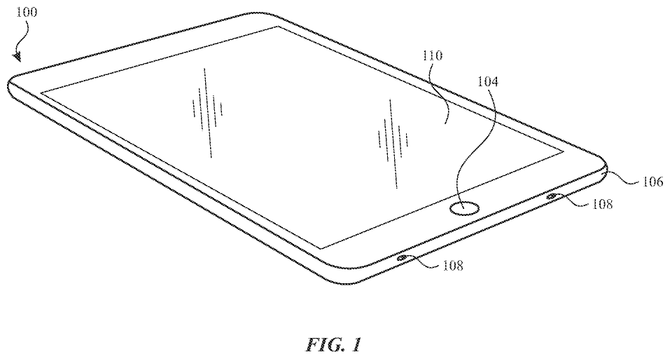

An illustrative electronic device that may display content and/or live session UI views is shown in FIG. 1. In the example of FIG. 1, electronic device 100 has been implemented using a housing that is sufficiently small to be portable and carried by a user (e.g., electronic device 100 of FIG. 1 may be a handheld electronic device such as a tablet computer, a smart phone, a smartwatch, a laptop, and the like). As shown in FIG. 1, electronic device 100 includes a display such as display 110 mounted on the front of housing 106. Electronic device 100 includes one or more input/output devices such as a touch screen incorporated into display 110, a button or switch such as button 104 and/or other input output components disposed on or behind display 110 or on or behind other portions of housing 106. Display 110 and/or housing 106 include one or more openings to accommodate button 104, a speaker, a light source, or a camera.

In the example of FIG. 1, housing 106 includes openings 108 on a bottom sidewall of housing 106. One or more of openings 108 forms a port for an audio component. Housing 106, which may sometimes be referred to as a case, may be formed of plastic, glass, ceramics, fiber composites, metal (e.g., stainless steel, aluminum, etc.), other suitable materials, or a combination of any two or more of these materials.

The configuration of electronic device 100 of FIG. 1 is merely illustrative. In other implementations, electronic device 100 may be a computer such as a computer that is integrated into, and/or communicatively coupled to, a display such as a computer monitor, a laptop computer, a set-top box device, a content streaming device, a wearable device such as a smart watch, a pendant device, or other wearable or miniature device, a media player, a gaming device, a navigation device, a computer monitor, a television, a headphone, or other electronic equipment having a display. In some implementations, electronic device 100 may be provided in the form of a wearable device such as a smart watch. In one or more implementations, housing 106 may include one or more interfaces for mechanically coupling housing 106 to a strap or other structure for securing housing 106 to a wearer.

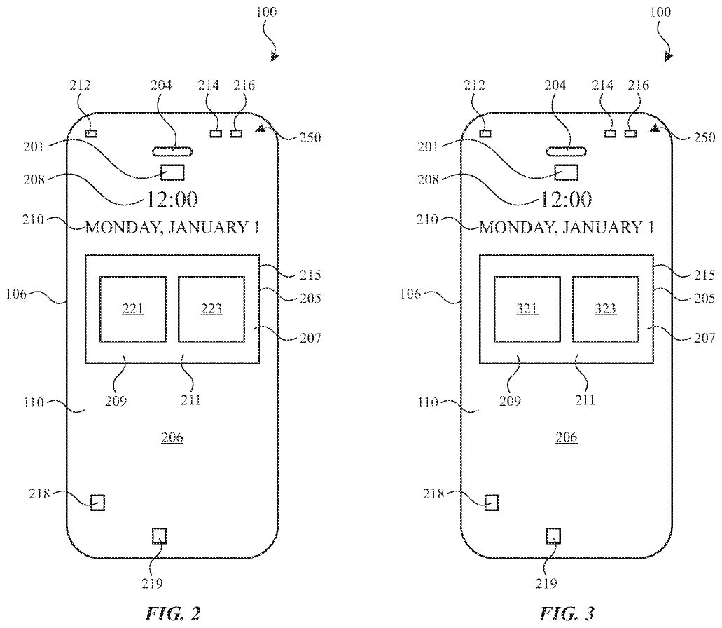

FIG. 2 illustrates an example of a live session UI view 205 displayed by the electronic device 100. In some embodiments, the UI view 205 is a system UI view (e.g., a view provided by an operation system of the electronic device 100). In one or more implementations, the UI view 205 may be a UI view for a widget. As illustrated in FIG. 2, the UI view 205 is displayed by a lock screen 250 of the electronic device. However, in some embodiments, the electronic device is configured to display live session UI views on any one of a lock screen (e.g., lock screen 250), a home screen, within another application and/or in a window that is overlaid on another application, and the like. In some embodiments, the UI view 205 is a UI view that is displayed by a system process.

In some implementations, the system process generates the UI view 205 in accordance with parameters provided by an application. In some implementations, the system process is an application framework that receives configuration data associated with an application, and generates the UI view 205 in accordance with the configuration data. In some implementations, the configuration data is included in a template data structure. In some implementations, the configuration data is defined using a declarative syntax.

In some implementations, the UI view includes at least one data element (e.g., first pre-defined region 209 or second pre-defined region 211) associated with system data (e.g., a battery indicator, a signal strength indicator, or a timer). In some implementations, the UI view includes at least one data element (e.g., first pre-defined region 209 or second pre-defined region 211) associated with application data (e.g., fitness tracking data, sports scores, etc.).

As shown in FIG. 2, the lock screen 250 is displayed by the electronic device 100 while the electronic device 100 is a locked state. For example, the electronic device 100 may include the housing 106 and the display 110 that displays the lock screen 250. In the example of FIG. 2, the lock screen 250 includes an unlock feature 219. The unlock feature 219 may be selectable by a user of the electronic device 100 to initiate an unlock procedure (e.g., a procedure in which the user provides and/or the device obtains authentication information to unlock the electronic device). In the example of FIG. 2, the lock screen 250 also includes a lock indicator 201 indicating that the electronic device is locked. In one or more implementations, when authentication information is received by the electronic device 100, and before the user provides an additional interaction to navigate away from the lock screen 250 (e.g., to another screen, such as a home screen or a user interface of an application or a system process), the lock indicator 201 may indicate that the electronic device 100 is unlocked for a period of time while the lock screen 250 continues to be displayed.

In the example of FIG. 2, the lock screen 250 also includes a carrier indicator 212, a signal strength indicator 214, a battery indicator 216, and a functional element 218 (e.g., a displayed element that can be used to access a limited functionality of the electronic device 100, such as a light source functionality or a camera functionality). In some implementations, one or more of the carrier indicator 212, signal strength indicator 214, battery indicator 216, and functional element 218 is displayed within a live session UI view. As shown in FIG. 2, the lock screen 250 may also include a background 206 (e.g., an image or a pattern of colors), a live session UI view 205 (e.g., a UI view in one or more states defined by a corresponding application or system process that is installed at the electronic device 100), and may include publicly available data, such as a time 208 and a date 210. In the example of FIG. 2, the electronic device 100 includes one or more sensing components 204 (e.g., a camera and/or an infrared sensor or depth sensor) that can be used for obtaining biometric authentication information from a user of the electronic device. In other examples, the electronic device 100 may obtain biometric or non-biometric (e.g., passcode) authorization information from other sensors and/or input components, such as a touch screen integrated into the display 110, or a keyboard or other input interface of the electronic device 100.

In the example of FIG. 2, the UI view 205 includes a background 207 within a border 215, a first pre-defined region 209, and a second pre-defined region 211. However, in other examples, the UI view 205 might include any number of pre-defined regions (e.g., 209). As shown, the first pre-defined region 209 may include a display of data 221. For example, the data may be additional data. The data 221 (e.g., the additional data) may be data received, by the system process, from the application at a time subsequent to the receipt of a template associated with the UI view. The data 221 may be inserted into the pre-defined region (e.g., pre-defined region 209), and the UI view may be rendered with the data 221 shown in the pre-defined region 209. Additionally, the data 221 may be received at a time prior to or simultaneous with the receipt, by the system process, of the template associated with the UI view. In one illustrative example, the data 221 may comprise data associated with a live event (e.g., a sporting event), or the live session data 221 may comprise data associated with an event that is updated on a periodic, sporadic, or continuous basis. The first pre-defined region 209 may include a display of the data 221. The second pre-defined region 211 may include a display of different data 223. In the example of FIG. 2, the UI view 205 is a bordered UI view having a border 215 that sets the UI view 205 apart from the background 206. In one or more other implementations, the UI view 205 may be a borderless display element. In a borderless state of the UI view 205, the first pre-defined region 209 and/or the second pre-defined region 211 and/or their respective associated data 221 and data 223 may be displayed to appear as integrated content with the background 206.

In some variations, one or more data (e.g., data 221 and/or data 223) displayed by a UI view (e.g., UI view 205) is obtained, by the electronic device 100, from an application running on the electronic device 100. In some variations, one or more of the data (e.g., data 221 and/or data 223) displayed by the UI view (e.g., 205) is obtained, by the electronic device 100, from a remote application server 610 (e.g., remote with respect to the electronic device 100) associated with the UI view. In some variations, the data is obtained, by the electronic device 100, from the remote application server 610. In some variations, the application sends the data to a data server 612 (e.g., a remote data server) associated with the electronic device 100, and the electronic device 100 obtains the data from the data server 612 associated with the electronic device 100.

In another illustrative example, the UI view 205 may include one or more graphical display elements (e.g., first pre-defined region 209 and/or second pre-defined region 211) of a sports-related application that is installed at the electronic device 100. The sports-related application may be inactive at the time of display of the UI view 205. In this example, the data 221 may be a current score of a first individual or team currently participating in a competitive sporting event (e.g., a basketball game, a football game, a soccer game, a hockey game, a golf match, a chess tournament, a rugby game, tennis match, a fencing tournament, bowling match, a curling match, or the like). In this example, the data 223 may be a current score of a second individual or team currently participating in (e.g., against the first individual or team) the sporting event. In various implementations, the data 221 and the data 223 may be obtained, by the electronic device 100, from an application server 610 associated with the sports-related application, while the sports-related application at the electronic device 100 is inactive at the electronic device 100. In this way, a UI view 205 can display dynamic (e.g., current, real-time, live) data without having to operate the sports-related application.

The example of a sports-related application and a sporting event are merely illustrative. In another illustrative example, a user of the electronic device 100 may be waiting for, or riding in, a rideshare vehicle associated with a rideshare application installed at the electronic device 100. The user may view a location of the rideshare vehicle, an estimated time of arrival, an estimated cost, or other dynamic and/or live data for the rideshare vehicle in a full user interface of the rideshare application (e.g., in a full user interface of the rideshare application, such as a user interface generated by the rideshare application and not by a system process). In this example use case, when the UI view 205 (generated by a system process) is displayed instead of the full user interface of the rideshare application (generated by the application), the UI view 205 may display some or all of the data associated with the rideshare vehicle. For example, the first pre-defined region 209 may display data 221 corresponding to a current location of the rideshare vehicle, and the second pre-defined region 211 may display data 223 corresponding to an estimated time of arrival of the rideshare vehicle.

In general, the UI view 205 may be a system-generated live session UI view (e.g., a system-generated notification, a status bar UI view, a toolbar UI view, a system tray view, a taskbar view, or other system-generated UI view that displays system-generated data, such as live data or dynamic data), a system-generated application-specific live session UI view that is separate from a full (application-generated) UI of an application and that can be displayed while the full UI of the application is inactive (e.g., minimized or closed), or an extension-generated live session UI view that can be generated by an extension operating in a restricted (e.g., sandbox) mode.

In the example of FIG. 2, the UI view 205 is displayed in a first state. In this first state, the UI view 205 includes first data 221 in a first pre-defined region 209 and second data 223 in a second pre-defined region 211, as well as the background 207 and the border 215. The first state may be defined by the underlying application for the UI view 205. For example, the first state may be defined by the underlying application prior to the electronic device displaying the UI view 205. In one or more implementations, the first state illustrated in the example of FIG. 2 may be one of several states of the UI view 205 that are defined by the underlying application.

FIG. 3 illustrates an example in which the electronic device 100 displays the UI view 205 in a second state that is different from the first state illustrated in FIG. 2. In the example of FIG. 3, the UI view 205 is in the second state. As shown in the example of FIG. 3, in the second state, the UI view 205 includes the background 207, the border 215 of the UI view 205, the first pre-defined region 209, and the second pre-defined region 211. While the UI view 205 is in the second state, the UI view 205 may include updated data 321 (e.g., first updated data) in the first pre-defined region 209 and updated data 323 (e.g., second updated data) in the second pre-defined region 211. For example, the updated data may be new live data to replace the first data. In an example of a sporting event, a first score for a first team may be displayed as data 221 in pre-defined region 209, and a second score for a second team may be displayed as data 223 in pre-defined region 211. If the first team and the second team each change their score, a third score for the first team may be displayed as data 321 in pre-defined region 209 and a fourth score for the second team may be displayed as data 323 in pre-defined region 211. While FIG. 3 shows updated data 321 and updated data 323, in some examples only the data in the first pre-defined region 209 is updated, while the data in the second pre-defined region 211 stays the same. For example, updated data 321 may be displayed in pre-defined region 209, while the initial data 223 may be presented in pre-defined region 211. In another example, the initial data 221 is displayed in pre-defined region 209 while updated data 323 is presented in pre-defined region 211. In other examples, there may be any number of pre-defined regions presented on the UI view 205. The UI view 205 may present one pre-defined region, three pre-defined regions, or more than three pre-defined regions.

In one or more implementations, the UI view 205 may transition from the first state shown in FIG. 2 to the second state shown in FIG. 3 in response to an update sent by the application. In another example, the UI view 205 may transition from the first state shown in FIG. 2 to the second state shown in FIG. 3 in response to an input from a user associated with the electronic device 100. For example, a user may enter an input requesting an update to the UI view 205, and the UI view 205 may be updated according to the user input. In another example, the UI view 205 may be updated based on receiving, by the system process, updated data from a remote data server 612. The system process may access the remote data server 612 on a periodic basis, and the system process may obtain updated data from the remote data server 612 after an update, of the data at the data server 612, such as by the application server 610. The system process may include a default update rate, and the system process may request updates to the data from the remote data server 612 based on the default update rate. The system process may receive an update cadence from the application. The system process may request updates to the data from the remote data server 612 based on the update cadence received from the application. The system may transition from the first state shown in FIG. 2 to the second state shown in FIG. 3 using a transition. For example, the transition may be an animation. For example, the first data 221 may be replaced, with an animation feature, with the data 321 in the pre-defined region 209. The animation may include any suitable animation, for example a fade in, a slide in, a spin, or any other suitable animation.

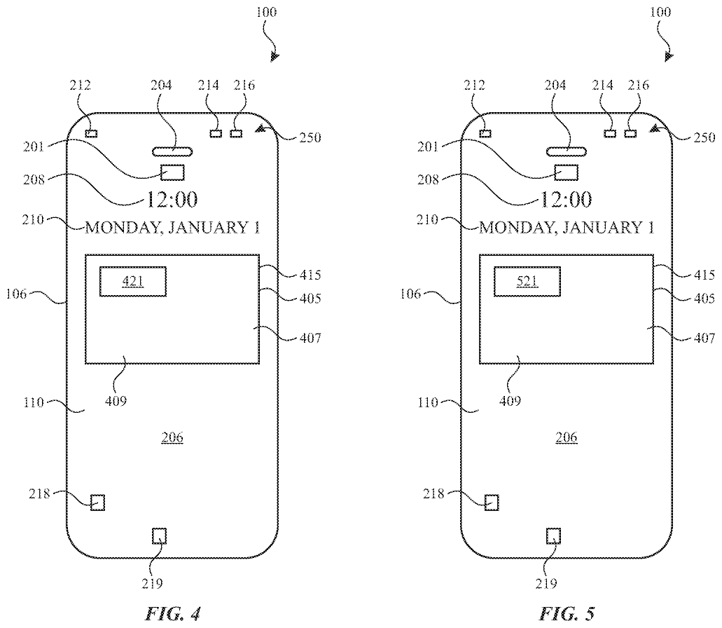

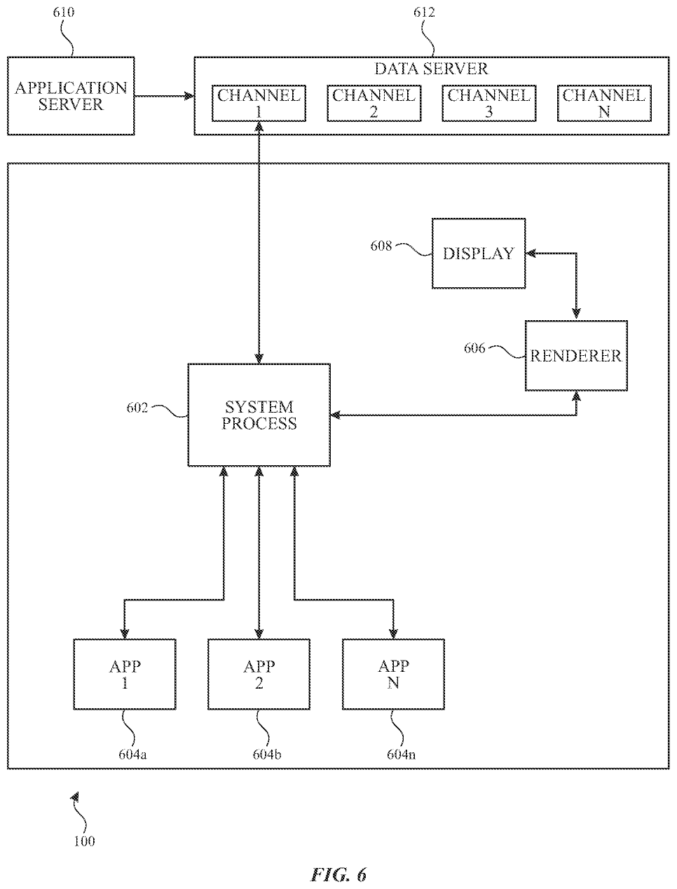

FIG. 4 shows an additional example of a UI view 405 associated with a lock screen 250 of an electronic device 100. For example, the UI view 405 in FIG. 4 may be a third state associated with the UI view 405. In the third state, the UI view 405 may be based on a different template than the template used to generate the UI view 205 shown in FIGS. 2 and 3. For example, FIGS. 2 and 3 may be generated based on a first template, and the differences between the UI views presented in FIGS. 2 and 3 may be limited to the data presented in the pre-defined regions 209 and 211. The UI view 405 be based on a different template. The different template may include different pre-defined regions than the template used to generate the UI view 205. For example, pre-defined region 409 may be a different size, a different shape, in a different location, or any other suitable differences. For example, the pre-defined region 409 may be presented in a corner of the UI view 405, rather than in a center of the UI view 405.

The different template used to generate the UI view 405 may be provided by the application. In one or more implementations, the different template used to generate the UI view 405 may be retrieved, by the system process, from the remote application server 610. The different template used to generate the UI view 405 may be retrieved, by the system process, from a remote data server 612 associated with the system process or the electronic device 100, wherein the remote data server 612 associated with the system process or the electronic device 100 may be configured to host information from the application. In another example, the remote data server 612 may be associated with a third party other than the application and the system process or the electronic device 100, and the third party data server 612 may be configured to host information from the application, and the third party data server 612 may be configured to be accessed by the system process.

The system process may receive an indication from the application of which template to use. For example, the system process may receive an indication from the application to generate a UI view 205 associated with a first template to display first data 221 in a pre-defined region 209 and second data 223 in a pre-defined region 211. In another example, the system process may receive an indication from the application to generate a UI view 405 associated with a second template to display data 421 in a pre-defined region 409. In another example, the system process may generate the UI view 205 based on the first template for a first period of time. Subsequent to the generating the UI view 205, the system process may render the UI view 405. The system process may transition the UI view 205 to the UI view 405. The transition may comprise an animation. In another example, the UI view 205 and the UI view 405 may be displayed on the lock screen 250 simultaneously.

FIG. 5 illustrates an example in which the electronic device 100 may display the UI view 405 in a fourth state that is different from the third state illustrated in FIG. 4. In the example of FIG. 5, the UI view 405 is in the fourth state. As shown in the example of FIG. 5, in the fourth state, the UI view 405 includes the background 407, the border 415 of the UI view 405, and the pre-defined region 409. While the UI view 405 is in the fourth state, the UI view 405 may include updated data 521 in the pre-defined region 409. For example, the updated data may be new live data to replace the first data 421. In an example of a user accessing personalized data, the data 421 may be personalized information, for example banking account information, displayed in a pre-defined region 409, and the rest of the UI view 405 may comprise static data associated with the banking application. If the user makes a transaction, updated data 521 may be displayed in the pre-defined region 409, rather than the data 421.

In the examples of FIGS. 2-5 the UI views 205 and 405 are shown as being displayed on the lock screen 250 of the electronic device 100, as examples of a screen on which live session UI views can be displayed. In implementations in which the UI view 205 and the UI view 405 are displayed and may be updated based on live or dynamic data, the UI view 205 and the UI view 405 can provide various technical advantages. For example, once a device is locked, in some devices, the entire system, including application data associated with applications installed at the electronic device can be encrypted. In order for a user to regain access to the data and/or functionality of the electronic device 100, the user is often required to provide authentication information that proves to the device that the user is an authorized user. As examples, the authentication information can include a passcode entered by the user, or biometric authentication information such as a fingerprint, a voice print, or facial feature information.

Following a locking event for an electronic device 100, the electronic device 100 may display a lock screen 250. While the electronic device 100 is locked and the lock screen 250 is displayed, the user can provide authentication information and/or the device can automatically obtain authentication information (e.g., by obtaining imaging or depth data associated with the user's finger or face), and unlock the electronic device 100 if the authentication information indicates that the user is an authorized user of the electronic device 100.

In one or more use cases, a user of an electronic device 100 can use the device to view or otherwise monitor an ongoing event in the physical world using an application installed at the electronic device. As examples, a sports-related application may be used to watch or track the score of a sporting event, a rideshare application may be used to monitor the location of a rideshare vehicle before or during a ride in the rideshare vehicle, or a delivery application may be used to monitor the status of an order and/or a location of a delivery vehicle. As another example, a nature-related application may be used to monitor a natural phenomenon such as a tide, a phase of the Moon, the weather, or the like.

It can be challenging to obtain and display data associated with an application on a lock screen 250 of an electronic device 100 without allowing the application to access data and/or resources that are locked from access in the locked state of the device. For example, it may be desirable to display data associated with an application while preventing the application itself from running on the electronic device and/or from receiving information about user interactions with the lock screen of the electronic device (e.g., information which is typically protected by the device until a user provides authentication information and seeks to interact with the application).

Aspects of the subject technology can provide a live session UI view displaying dynamic data, such as the UI view 205 of FIGS. 2 and 3, and UI view 405 of FIGS. 4 and 5, in a way that is power efficient and maintains user privacy and/or device security while an electronic device is in a locked state. For example, by providing state definitions, trigger definitions, and/or transition definitions to the system process of the electronic device 100 before the electronic device 100 enters a locked state, the UI view 205 and the UI view 405 can be displayed on the lock screen 250 in a way that appears to be responsive to user interactions, data triggers, and/or other content on the lock screen 250, without allowing the underlying application to receive information about user interactions with the electronic device or other content displayed on the lock screen while the electronic device 100 is in the locked state. In this way, the privacy that the user may expect when the user's device is locked can be maintained and protected.

In various implementations described herein, whether a live session UI view with dynamic data is displayed on lock screen, a home screen, or any other user interface of an electronic device, in addition to privacy, power-efficiency, and/or computing-resource efficiency advantages, aspects of the subject technology can also provide advantages in terms of developer and user efficiency. For example, a developer of an application can provide information to a system process of an electronic device that allows the system process to animate aspects of a UI view for application information, without the developer having to create or provide code for the animations.

In another example, the live session UI view can be updated based on one or more triggers. The triggers may be determined by the system process or the triggers may be received, by the system process, from the application. For example, a UI view 205 may be associated with a ride-share application. The ride-share application may indicate that a ride will arrive in 60 minutes. Based on the amount of time until the ride arriving, the data displayed in the UI view 205 may be updated at a lower frequency. For example, the data displayed in the UI view 205 may be updated every minute, every two minutes, every 30 seconds, or the like. The ride-share application may indicate that a ride will arrive in 2 minutes. Based on the amount of until the ride arriving being 2 minutes, the data displayed in the UI view 205 may be updated at a higher frequency. For example, the data displayed in the UI view 205 may be updated every second, every 5 seconds, every 10 seconds, or the like.

FIG. 6 illustrates an example architecture that may be implemented by the electronic device 100 in accordance with one or more implementations of the subject technology. For explanatory purposes, portions of the architecture of FIG. 6 is described as being implemented by the electronic device 100 of FIG. 1, such as by a processor and/or memory of the electronic device; however, appropriate portions of the architecture may be implemented by any other electronic device. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

Various portions of the architecture of FIG. 6 can be implemented in software or hardware, including by one or more processors and a memory device containing instructions, which when executed by the processor cause the processor to perform the operations described herein. In the example of FIG. 5, the electronic device 100 includes hardware components such as display 110. In this example, the electronic device 100 also includes one or more logical process such as a system process 602, and/or one or more applications 604a-604n. For example, the system process 602 and/or the one or more applications 604a-n may be logical processes that are executed from a memory by one or more processors of the electronic device 100. The system process 602 may be, for example, a process defined in hardware and/or as part of an operating system of the electronic device 100.

In FIG. 6, the electronic device 100 may store code for three applications (e.g., App 1 604a, App 2 604b, and App N 604n). However, this is merely illustrative, and it is understood that the electronic device 100 can store code for one application 604, two applications 604, more than three applications 604, or generally any number of applications 604. The applications 604 may, for example, have been previously downloaded to the electronic device 100 and installed at the electronic device 100. One or more of the applications 604 may be associated with a UI view (e.g., UI view 205 or UI view 405) that displays data that can be periodically, occasionally, or continuously dynamic data (e.g., application-specific information, system status information, and/or information associated with a physical world event as discussed herein), while the application 604 and/or a full user interface of the application 604 is inactive.

In FIG. 6, the applications 604 are in communication with the system process 602. The applications 604 can provide one or more templates and additional information to the system process 602. For example, App 1 may provide, to the system process 602, one or more templates associated with a live session UI view. App 1 may provide, to the system process 602, one or more definitions associated with the one or more templates. The system process may store the definitions associated with App 1, for example in a memory associated with the system process. The system process may use the definitions associated with App 1 to display the UI view 205 and/or the UI view 405, as shown in FIGS. 2-5.

The definitions associated with App 1 may include definitions of one or more templates associated with App 1. The one or more templates may have static data associated with the templates. Static data associated with a particular template may always be present in a UI view associated with the particular template. The templates may include one or more pre-defined regions that can be inserted with additional data (e.g., data 221, 223, etc.). The additional data may be live data. The additional data may be personalized data. The additional data may be dynamic data. The additional data may be provided by the application or by a remote application server 610 associated with the application. A single application may generate or provide, to the system process, one or more templates. The system process may render the UI view (e.g., UI view 205 and UI view 405) based on the one or more templates. The system process may render the UI view including a single one of the one or more templates, or the system process may render the UI view including multiple templates from the same application. The system process may render the UI view including multiple templates from multiple different applications. Each different templates may display different data on a lock screen (e.g., lock screen 250) of the electronic device 100.

The definitions may include definitions for UI elements of a UI view, state transitions for the UI view, sizes for one or more UI elements of the UI view, shapes for the one or more elements of the UI view, locations for the one or more UI elements of the UI view, and a layout of the UI elements of the UI view. The definitions may define a graphical object displayed on the UI view.

The providing of the state definitions illustrated in FIG. 6 may be performed in advance of the corresponding a UI view (for which the state definitions define one or more states) being displayed, so that the system process 602 of the electronic device 100 can render the corresponding graphical having the data, and the layout, size, and/or other visual features of the UI view in any of various states defined in the state definitions for at least a period of time while the application itself is inactive.

As shown in FIG. 6, an application server 610 may be in communication with a data server 612 (e.g., a remote server), and the system process 602 may be in communication with a channel of the data server (e.g., channel 1). The system process 602 may receive data corresponding to an application from the data server. For example, the system process 602 may receive data associated with Appl 604a from the data server 612. The data server 612 may be remote from the electronic device 100. In one example, App 1 604a sends definitions to system process 602, wherein the definitions comprise an indication of an identifier associated with one or more communication channels of the data server 612. For example, the system process 602 may use the one or more identifiers (e.g., an identifier, a link, a token, or a handle) to access a channel of the remote server 612 to retrieve data associated with App 1 604a.

The one or more channels may be publication channels. The publication channels may publish data for other devices to retrieve from the publication channels. The applications 604 may have access to the publication channels to publish data associated with the applications 604 on one or more of the channels of the data server 612. The system process 602 may, using the identifier of the publication channel, subscribe to the publication channel. The applications 604 may publish dynamic data at the publication channels, and the system process 602 may access the data published by the publication channels. The publication channels may be hosted by one or more remote servers. The one or more remote servers may be associated with the applications 604a-n. After accessing the data, the system process may store the data on the electronic device 100 (e.g., in a memory).

In one example illustrated in FIG. 6, the system process 602 receives a template from an application 604 (e.g., App 1 604a), and the system process subscribes to a Channel on a data server 612 associated with App 1. The system process 602 retrieves live session data from the Channel 1 channel, and the system process causes, via the renderer 606, a UI view (e.g., UI view 205) to be displayed, at display 608, including the template and the data. The data may be inserted into one or more pre-defined regions of the template. For example, the UI view displaying the template and the data may be UI view 205 with the template including pre-defined region 209 including data 221 and pre-defined region 211 including data 223.

The UI view (e.g., UI view 205) can be updated periodically to ensure the live session data is sufficiently accurate. For example, the UI view 205 may be updated every 10 seconds. The update frequency may be determined by the application. The update frequency may be determined by the system process 602. In one or more implementations, the update frequency may be based at least in part on a data change rate of a corresponding live event. For example, the update frequency for a score of a soccer or baseball game may be lower than the update frequency for a score of a basketball game, since the data change rate of a baseball or soccer game score is lower than the data change rate of a basketball game score.

In one or more implementations, there may be a limit to the frequency with which the UI view may be updated. The system process may balance the periodicity of the updates to maximize data accuracy, without causing too much strain on the resources of the electronic device 100, such as a battery life or a computing power. In one example, the system process 602 may determine that a user is not actively interacting with the UI view. Based on the inactivity, the system process 602 may pause all updates to the live session data. In another example, a user associated with the electronic device 100 may request a pause of updates to the UI view. The live session UI view may not be updated until the user requests a resumption of the updates. In one example, new data may be published at Channel 1, but the system process may not access the new data while the UI view is inactive. Upon determining a user is interacting with the UI view or the electronic device, the system process may un-pause the updates and begin updating the live session data on the UI view.

In the above example, the system process 602 may determine first data (e.g., data 221 and data 223) on Channel 1 of the data server 612. The system process may also determine a template associated with an application (e.g., App 1) associated with the published data. The system process 602 may cause a UI view 205 to be rendered including the template and the data in the pre-defined regions of the template. For example, the system process 602 may cause the UI view 205 to be rendered with the data 221 inserted into the pre-defined region 209 and the data 223 to be inserted into the pre-defined region 211. At a subsequent time, the system process 602 may query the Channel 1 to request updated data. The system process 602 may determine that the application has published additional and/or updated data at the Channel 1 of the data server 612. The system process 602 may access the updated data and update the UI view 205 with the updated data. For example, the system process 602 may transition the UI view 205 shown in FIG. 2 to the UI view 205 shown in FIG. 3. For example, the system process 602 may replace the data 221 in pre-defined region 209 with the updated data 321, and the system process 602 may replace the data 223 in pre-defined region 211 with the updated data 323.

In another example, the system process 602 may access data from the data server 612 associated with multiple applications and/or multiple templates. Each piece of data may be associated with an identifier to identify which application and/or template the data corresponds to. For example, the system process 602 may cause a UI view to be rendered on a lock screen with two different templates from two different applications. To determine which data is associated with which pre-defined region of which template, the data may be tagged with an identifier to define which application, template, and pre-defined region the data is associated with. The system process 602 may receive the data and the identifier, and the system process 602 may use the identifier to determine how and/or where to render the data in the user interface view 205.

In another example, a system process may transition a UI view from a currently rendered view to a newly rendered view. The currently rendered view may be associated with an extension process executing in a restricted mode (e.g., a sandbox mode) of the electronic device 100. For example, a restricted mode may comprise an isolated environment on the electronic device 100 that separates specific code and/or data from the rest of an application, the electronic device 100, or a network. The restricted mode may prevent unintended errors or malicious actions by the code in the restricted mode because the code is not executing on an open environment of the electronic device 100. In some examples, the restricted mode, such as a sandbox mode, may be a testing environment with some functionality to allow for code executing in the restricted mode to take some actions without affecting the overall electronic device 100. The system process 602 may request, from the extension process executing in the restricted mode, the newly rendered UI view. The system process may cause a transition from the currently rendered UI view to the newly rendered UI view. For example, the transition can be an animation. The animation can be any animation contemplated herein, such as a slide in, a fade in, or any other suitable animation.

In another example, the system process may request a newly rendered view from a second extension process executing in a same or a different restricted mode, the newly rendered UI view. The system process may cause a transition from the currently rendered UI view to the newly rendered UI view. For example, the transition can be an animation. The animation can be any animation contemplated herein, such as a slide in, a fade in, or any other suitable animation. The currently rendered view may include a template with dynamic data (e.g., live session data) inserted into one or more pre-defined regions of the template and rendered into a UI view. The newly rendered view may include the template with updated dynamic data. The updated dynamic data may replace the dynamic data inserted into the one or more pre-defined regions, and the newly rendered UI view may display the updated dynamic data on the UI view.

The extension process may execute on the electronic device 100 in one or more modes. The modes may be restricted in one or more ways. The extension processes may have less permissions when executing in the restricted mode. For example, the restriction may be determined based on a mode of the extension process. In one example, the extension process may be executing in a rendering mode, where the extension process renders the template and data into a UI view. In the rendering mode, the extension process may not have access to a network. In the rendering mode, the extension process may not be accessible by a user of the electronic device 100. While executing in the rendering mode, the system process may retrieve data from subscription channel and send the data to the extension process. Therefore, even without network access, the extension process may still access updated data and render an updated UI view. In another example, the extension process may be executing in a data fetch mode. While executing in the data fetch mode, the extension process may have network access. For example, the extension process may be able to access a publication channel to request updated dynamic data to be used when rendering the newly rendered UI view. In another example, the extension process may be executing in an editing mode. While in the editing mode, the extension process may have a limited access to a network and a limited access to receive user inputs.

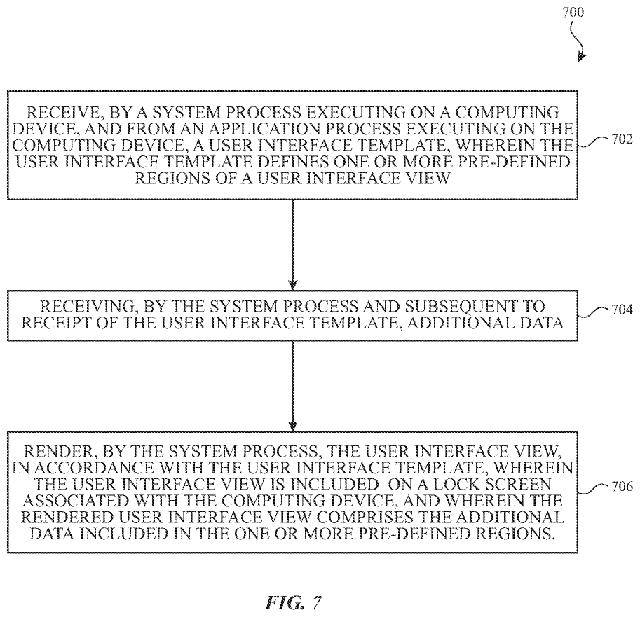

FIG. 7 illustrates a flow diagram of an example process for live session user interface views, according to aspects of the subject technology. The blocks of process 700 are described herein as occurring in serial, or linearly. However, multiple blocks of process 700 may occur in parallel. In addition, the blocks of process 700 need not be performed in the order shown and/or one or more blocks of process 700 need not be performed and/or can be replaced by other operations. In some embodiments, a system process (e.g., system process 602) of an operating system of an electronic device performs the process of FIG. 7. In some implementations, the system process is a user interface view display process (e.g., a process for displaying widgets, etc.). In other embodiments, a user interface view display process (e.g., a process for displaying widgets, etc.) separate from an operating system of the electronic device performs the process of FIG. 7.

In the example of FIG. 7, at block 702, a system process (e.g., system process 602) executing on a computing device (e.g., electronic device 100) receives, from an application process (e.g., App 1 604a) executing on the computing device, a user interface template, wherein the user interface template defines one or more pre-defined regions (e.g., 209, 211) of a user interface view (e.g., UI view 205). In one or more implementations, the user interface view may be a user interface view for a widget for the application. At block 704, the system process (e.g., system process 602) receives, subsequent to receipt of the user interface template, additional data (e.g., data 221 and data 223).

At block 706, the system process (e.g., system process 602) renders the user interface view (e.g., UI view 205) in accordance with the user interface template, wherein the user interface view (e.g., UI view 205) is included on a lock screen (e.g., lock screen 250) associated with the computing device, and wherein the rendered user interface view (e.g., 205) comprises the additional data (e.g., 221 and 223) included in the one or more pre-defined regions (e.g., 209 and 211). For example, the application process may be related to displaying information associated with a sporting event. The system process (e.g., 602) may receive, from the application process, a user interface template, wherein the user interface template defines one or more pre-defined regions of a user interface view (e.g., 205) on a lock screen (e.g., 250). The system process (e.g., 602) may access the additional data from a publication channel (e.g., data server 612) associated with the application process. The data may comprise any number of types of dynamic data for presentation on the UI view (e.g., 205). For example, when the application process is associated with a sporting event, the additional data may comprise one or more team names associated with teams competing in the sporting event, one or more individual names of individuals competing in the sporting event, a score of one or more of the teams or individuals, a time left in the event, etc.

In another example, the system process (e.g., 602) may receive a database or dictionary of data prior to the determination to display the user interface view (e.g., 205) on the lock screen (e.g., 250). For example, the system process may receive a list of each team associated with the application process. For example, if the application process is associated with a National Basketball Association (NBA) league, the system process may receive a list of each team name associated with the NBA. Additionally, the database may comprise a list of names of each individual player associated with one or more of the NBA teams. For example, the list of individual names may comprise each person on one or more of the NBA team rosters. The database may also include indicators of associations between multiple data points in the database. For example, an indication may be provided that an individual player is associated with a specific team. For example, the database may indicate that Klay Thompson plays for the Golden State Warriors. In another example, each of the pieces of information, such as the team names and/or individual player names, may be associated with an indicator. For example, the Golden State Warriors may be associated with the indicator “team_4,” and Klay Thompson may be associated with the indicator “player_15.” For example, each player associated with the application may be associated with a unique indicator. The system process may access, at the publication channel (e.g., data server 612), additional data to be used to generate the user interface view (e.g., 205) associated with an NBA game. For example, the system process (e.g., 602) may retrieve an indicator, such as, “team_4; player_15; points_9.” The system process may query the database with the received additional data, and the system process may determine to generate the user interface view with information in the pre-defined regions (e.g., 209) to indicate the Golden State Warriors are playing a game, and player Klay Thompson has scored 9 points in the game.

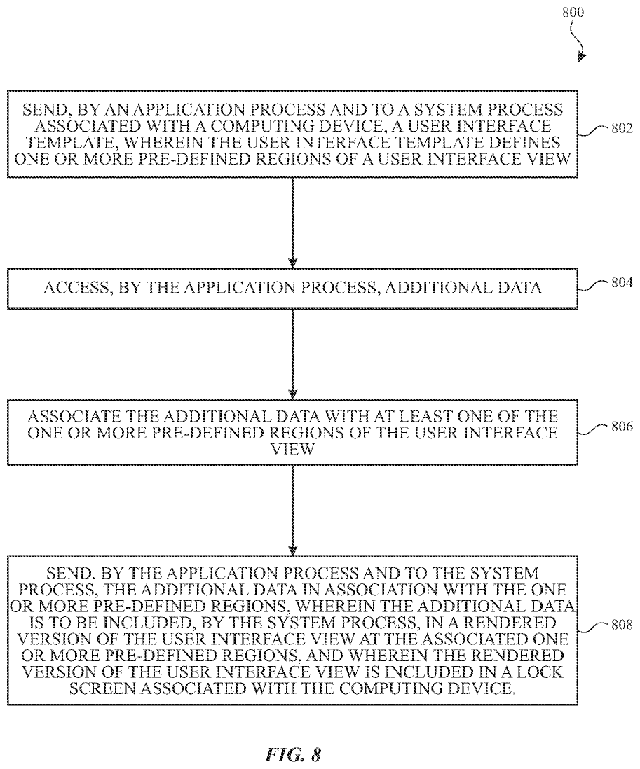

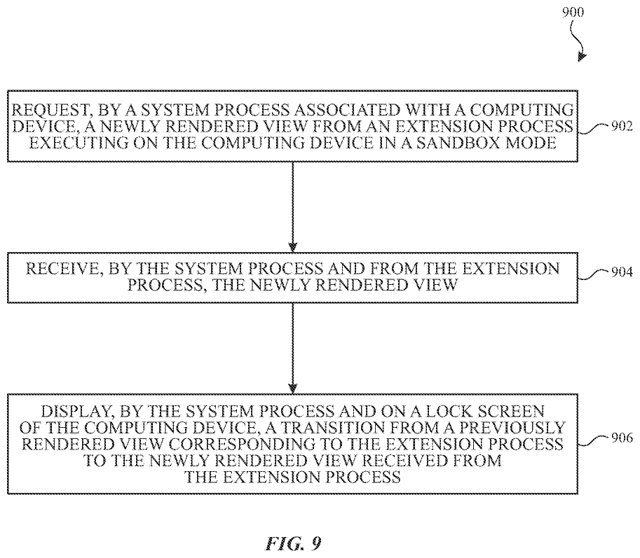

FIG. 8 illustrates a flow diagram of an example process for providing live session user interface views, according to aspects of the subject technology. The blocks of process 800 are described herein as occurring in serial, or linearly. However, multiple blocks of process 800 may occur in parallel. In addition, the blocks of process 800 need not be performed in the order shown and/or one or more blocks of process 800 need not be performed and/or can be replaced by other operations.

In the example of FIG. 8, at block 802, an application process (e.g., App 1 604a) sends to a system process (e.g., 602) associated with a computing device (e.g., 100), a user interface template, wherein the user interface template defines one or more pre-defined regions (e.g., 209 and 211) of a user interface view (e.g., 205).

At block 804, the application process (e.g., 604a) accesses the additional data (e.g., 221 and 223). At block 806, the application process (e.g., 604a) associates the additional data (e.g., 221 and 223) with at least one of the one or more pre-defined regions (e.g., 209 and 211) of the user interface view (e.g., 205).

At block 808, the application process (e.g., 604a) sends to the system process (e.g., 602), the additional data (e.g., 221 and 223) in association with the one or more pre-defined regions, wherein the additional data is to be included, by the system process, in a rendered version of the user interface view at the associated one or more pre-defined regions, and wherein the rendered version of the user interface view Is included in a lock screen (e.g., 250) associated with the computing device.

FIG. 9 illustrates a flow diagram of an example process for transitioning from a rendered user interface view to a newly rendered user interface view, according to aspects of the subject technology. The blocks of process 900 are described herein as occurring in serial, or linearly. However, multiple blocks of process 900 may occur in parallel. In addition, the blocks of process 900 need not be performed in the order shown and/or one or more blocks of process 800 need not be performed and/or can be replaced by other operations.

In the example of FIG. 9, at block 902, a system process (e.g., 602) on a computing device (e.g., 100) requests a newly rendered view from an extension process executing on the computing device, wherein the extension process is executing in a restricted (e.g., sandbox) mode on the computing device.

At block 904, the system process (e.g., 602) receives, from the extension process, the newly rendered view (e.g., 205 shown in FIG. 3). At block 906, the system process (e.g., 602) displays, on a lock screen (e.g., 250) of the computing device, a transition from a previously rendered view corresponding to the extension process to the newly rendered view received from the extension process. For example, the currently rendered view may be associated with a sporting event, and the currently rendered view may display a score of the sporting event on the lock screen. The system process may determine an update to the score, and the system process may request the newly rendered view to show the updated score. For example, during a basketball game, the score may be 33 to 27. In one example, the first team may score a two point score, and the score of the basketball game may change to 35 to 27. The system process may determine the score change and request the newly rendered view to display the 35 to 27 score on the lock screen.

As described above, aspects of the subject technology may include the collection and transfer of data from an application to other users' computing devices. The present disclosure contemplates that in some instances, this collected data may include personal information data that uniquely identifies or can be used to identify a specific person. Such personal information data can include demographic data, location-based data, online identifiers, telephone numbers, user activity data, user power consumption data, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used in providing content on an electronic device. Further, other uses for personal information data that benefit the user are also contemplated by the present disclosure. For instance, health and fitness data may be used, in accordance with the user's preferences to provide insights into their general wellness, or may be used as positive feedback to individuals using technology to pursue wellness goals.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates implementations in which users selectively block the use of, or access to, personal information data. That is, the present disclosure contemplates that hardware and/or software elements can be provided to prevent or block access to such personal information data. For example, in the case of providing dynamic lock screen content on an electronic device, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

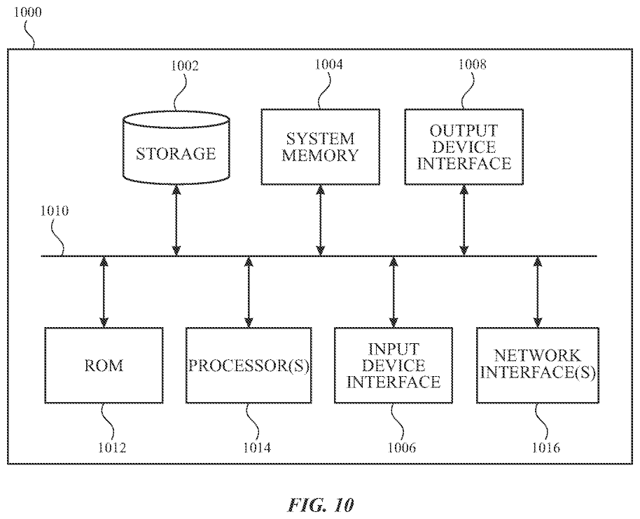

FIG. 10 illustrates an example computing device with which aspects of the subject technology may be implemented in accordance with one or more implementations. The computing device 1000 can be, and/or can be a part of, any computing device or server for generating the features and processes described above, including but not limited to a laptop computer, a smartphone, a tablet device, a wearable device such as smart watch, and the like. The computing device 1000 may include various types of computer readable media and interfaces for various other types of computer readable media. The computing device 1000 includes a permanent storage device 1002, a system memory 1004 (and/or buffer), an input device interface 1006, an output device interface 1008, a bus 1010, a ROM 1012, one or more processing unit(s) 1014, one or more network interface(s) 1016, and/or subsets and variations thereof.

The bus 1010 collectively represents all system, peripheral, and chipset buses that communicatively connect the numerous internal devices of the computing device 1000. In one or more implementations, the bus 1010 communicatively connects the one or more processing unit(s) 1014 with the ROM 1012, the system memory 1004, and the permanent storage device 1002. From these various memory units, the one or more processing unit(s) 1014 retrieves instructions to execute and data to process in order to execute the processes of the subject disclosure. The one or more processing unit(s) 1014 can be a single processor or a multi-core processor in different implementations.

The ROM 1012 stores static data and instructions that are needed by the one or more processing unit(s) 1014 and other modules of the computing device 1000. The permanent storage device 1002, on the other hand, may be a read-and-write memory device. The permanent storage device 1002 may be a non-volatile memory unit that stores instructions and data even when the computing device 1000 is off. In one or more implementations, a mass-storage device (such as a magnetic or optical disk and its corresponding disk drive) may be used as the permanent storage device 1002.

In one or more implementations, a removable storage device (such as a floppy disk, flash drive, and its corresponding disk drive) may be used as the permanent storage device 1002. Like the permanent storage device 1002, the system memory 1004 may be a read-and-write memory device. However, unlike the permanent storage device 1002, the system memory 1004 may be a volatile read-and-write memory, such as random access memory. The system memory 1004 may store any of the instructions and data that one or more processing unit(s) 1014 may need at runtime. In one or more implementations, the processes of the subject disclosure are stored in the system memory 1004, the permanent storage device 1002, and/or the ROM 1012. From these various memory units, the one or more processing unit(s) 1014 retrieves instructions to execute and data to process in order to execute the processes of one or more implementations.

The bus 1010 also connects to the input and output device interfaces 1006 and 1008. The input device interface 1006 enables a user to communicate information and select commands to the computing device 1000. Input devices that may be used with the input device interface 1006 may include, for example, alphanumeric keyboards and pointing devices (also called “cursor control devices”). The output device interface 1008 may enable, for example, the display of images generated by computing device 1000. Output devices that may be used with the output device interface 1008 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information.

One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 10, the bus 1010 also couples the computing device 1000 to one or more networks and/or to one or more network nodes through the one or more network interface(s) 1016. In this manner, the computing device 1000 can be a part of a network of computers (such as a LAN, a wide area network (“WAN”), or an Intranet, or a network of networks, such as the Internet. Any or all components of the computing device 1000 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components (e.g., computer program products) and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method comprising:
receiving, by a system process executing on a computing device, and from an application process executing on the computing device, a user interface template, wherein the user interface template defines one or more pre-defined regions of a user interface view;
receiving, by the system process and subsequent to receipt of the user interface template, additional data; and
rendering, by the system process, the user interface view, in accordance with the user interface template, wherein the user interface view is included on a lock screen associated with the computing device, and wherein the rendered user interface view comprises the additional data included in the one or more pre-defined regions.

2. The method of claim 1, further comprising:
receiving, from the application process, updated additional data; and
replacing the additional data with the updated additional data.

3. The method of claim 1, wherein the receiving additional data further comprises receiving, from the application process, the additional data.

4. The method of claim 1, further comprising:
receiving, by the system process and from the application process, an identifier associated with a channel of a remote server, wherein the channel publishes the additional data;
subscribing, by the system process, to the channel; and
receiving, by the system process and from the remote server, the additional data.

5. The method of claim 1, wherein the system process may render a plurality of user interface views on the lock screen simultaneously.

6. The method of claim 1, further comprising:
determining, by the system process and based at least in part on a lack of interaction with the lock screen, a pause to updates associated with user interface views rendered on the lock screen.

7. The method of claim 1, wherein a frequency of updates to the user interface view rendered on the lock screen is determined based at least in part on the additional data.

8. The method of claim 1, wherein the user interface template is a first user interface template of a plurality of user interface templates, further comprising:
receiving, by the system process and from the application process, an indication of at least one of the plurality of user interface templates; and
rendering, by the system process and based at least in part on the indication of the at least one of the plurality of user interface templates, the user interface view.

9. The method of claim 1, wherein the user interface view is associated with a session corresponding to a physical world event, and wherein the system process removes the user interface view from the lock screen based at least in part on an end to the physical world event.

10. A method comprising:
sending, by an application process and to a system process associated with a computing device, a user interface template, wherein the user interface template defines one or more pre-defined regions of a user interface view;
accessing, by the application process, additional data;
associating the additional data with at least one of the one or more pre-defined regions of the user interface view; and
sending, by the application process and to the system process, the additional data in association with the one or more pre-defined regions,
wherein the additional data is to be included, by the system process, in a rendered version of the user interface view at the associated one or more pre-defined regions, and wherein the rendered version of the user interface view is included in a lock screen associated with the computing device.

11. The method of claim 10, further comprising:
determining, by the application process, updated additional data; and
sending, by the application process and to the system process, the updated additional data.

12. The method of claim 10, further comprising:
publishing, by the application process and to a channel of a remote server, the channel associated with the application process, the additional data; and
sending, by the application process and to the system process, an identifier associated with the channel, wherein the system process may subscribe to the channel to receive the additional data.

13. The method of claim 10, wherein the application process associates the additional data with a template identifier, and wherein the template identifier is associated with the user interface template.

14. The method of claim 10, wherein the user interface template is a first user interface template, further comprising:
generating, by the application process, a second user interface template;
sending, by the application process and to the system process, the second user interface template; and
sending, by the application process and to the system process, an indication to render the user interface view using the first user interface template.

15. The method of claim 10, wherein the application process generates a plurality of user interface templates, and wherein the application process sends, to the system process, an indication to render the user interface view using at least two of the plurality of user interface templates.

16. The method of claim 10, wherein the additional data is associated with a physical world event, further comprising:
determining, by the application process, an end to the physical world event; and
sending, by the application process and to the system process, an indication of the end to the physical world event.

17. A method comprising:
requesting, by a system process associated with a computing device, a newly rendered view from an extension process executing on the computing device in a sandbox mode;
receiving, by the system process and from the extension process, the newly rendered view; and
displaying, by the system process and on a lock screen of the computing device, a transition from a previously rendered view corresponding to the extension process to the newly rendered view received from the extension process.

18. The method of claim 17, wherein the transition comprises an animation.

19. The method of claim 17, wherein the extension process is a first extension process, further comprising:
requesting, by the system process and from a second extension process executing in a second sandbox mode, a second newly rendered view; and
displaying, by the system process and on the lock screen, a transition from the first newly rendered view to the second newly rendered view.

20. The method of claim 17, wherein the previously rendered view corresponds to a user interface template associated with data received from an application process, and wherein the newly rendered view corresponds to the user interface template associated updated data received from the application process.
